(19) United States
(12) Patent Application Publication
(10) Pub. No.: US 2025/0272847 A1
(43) Pub. Date: Aug. 28, 2025

(54) CONTOUR-BASED SNAPPING OF GRAPHICAL OBJECTS

(71) Applicant: Adobe Inc., San Jose, CA (US)

(72) Inventors: Siddharth J. Singh, Noida (IN); Vivek Agrawal, Noida (IN); Nilesh Mishra, Noida (IN); Deepanjana Chakravarti, San Mateo, CA (US)

(21) Appl. No.: 18/585,602

(22) Filed: Feb. 23, 2024

(51) Int. Cl. G06T 7/13; G06T 7/11; G06T 7/246; G06T 11/00

(52) U.S. Cl. CPC G06T 7/13; G06T 7/11; G06T 7/246; G06T 11/00; G06T 2200/24; G06T 2207/20021; G06T 2210/12; G06T 2210/21

(57) ABSTRACT

In some embodiments, a computing system provides a graphical interface that displays one or more graphical objects including a moving object and a static object. The computing system generates an impact contour for the moving object that has a predefined distance from a first boundary of the moving object. Based on detecting that the impact contour of the moving object intersects a second boundary of the static object, the computing system determines a first snapping point on the first boundary of the moving object and a second snapping point on the second boundary of the static object. The computing system updates the graphical interface to execute a snapping operation by translating the moving object to a location where the first snapping point and the second snapping point touch each other.

### TECHNICAL FIELD

This disclosure relates generally to computer-implemented methods and systems for computer graphics processing. Specifically, the present disclosure involves snapping graphical objects by identifying collision points on object contours.

### BACKGROUND

In computer graphics processing, snapping is a process employed in certain computer graphics processing applications to automatically align and couple graphical elements with each other when moving, resizing, or drawing the graphical elements. For example, object snapping can be used to snap objects directly to other objects along respective edges. As a selected object nears a target object, the computer graphics processing application can automatically update a position of the selected object to align with the target object. Existing object snapping techniques are limited to rectangular bounding boxes surrounding the objects. These existing techniques do not provide snapping with respect to a shape boundary of the objects. As a result, a user attempting to manually couple two objects based on a respective shape boundary of the objects may produce an output design with noticeable overlap between the two objects.

### SUMMARY

Certain embodiments involve snapping graphical objects by identifying collision points on object contours. In one example, a computing system outputs a graphical interface that displays a set of graphical objects that includes a static object and a moving object. The moving object is selected and moved in the graphical interface from an original location to a destination location based on user input. The computing system generates an impact contour for the moving object. The impact contour has a predefined distance from a boundary of the moving object and translates with the moving object as the moving object is moved from the original location to the destination location. The impact contour can maintain the predefined distance from the boundary of the moving object during and after being translated to the destination location. Based on detecting that the impact contour of the moving object intersects a static boundary of the static object, the computing system determines a subject snapping point on the translated boundary of the moving object and a target snapping point on the static boundary of the static object. The computing system updates the graphical interface to execute a snapping operation by translating the moving object to the destination location where the subject snapping point and the target snapping point touch each other.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for snapping graphical objects by identifying snapping points on object contours, according to certain embodiments of the present disclosure.

FIG. 2 depicts an example of a process for snapping graphical objects by identifying snapping points on object contours, according to certain embodiments of the present disclosure.

FIG. 3 depicts an example of a process for determining a respective snapping point for a moving object and a static object, according to certain embodiments of the present disclosure.

FIG. 4 depicts an example of a schematic including a pair of intersection points bounding a subject region of interest for a moving object and a target region of interest for a static object, according to certain embodiments of the present disclosure.

FIG. 5 depicts an example of a schematic including a pair of snapping points determined based on a similarity search of surface tangents, according to certain embodiments of the present disclosure.

FIG. 6 depicts an example of an output design including a moving object snapped to a static object by identifying collision points on object contours, according to certain embodiments of the present disclosure.

FIG. 7 depicts an example of a schematic including a snapping point on a corner of a static object, according to certain embodiments of the present disclosure.

FIG. 8 depicts an example of a schematic including a snapping point on a line segment forming a corner of a static object, according to certain embodiments of the present disclosure.

FIG. 9 depicts an example of a computing system suitable for performing certain embodiments of the present disclosure.

### DETAILED DESCRIPTION

The present disclosure involves snapping graphical objects by identifying a respective collision point (e.g., a respective intersection point) on a moving object and a static object of the graphical objects. The collision points can be determined based on an impact contour for the moving object. As discussed above, existing object snapping methods often generate unsatisfactory results especially with respect to snapping to a shape boundary (e.g., contours) of an object. Certain embodiments described herein address these limitations by accounting for a shape boundary of the moving object involved in a snapping operation. For instance, a computer graphics processing application can generate the impact contour for the moving object to match the shape boundary of the moving object. Based on intersection points between the impact contour and a boundary of a static object, the computer graphics processing application can determine a respective region of interest for the moving object and the static object. The computer graphics processing application then can determine a respective snapping point for the moving object and the static object in the respective regions of interest by applying a similarity search to surface tangents in each region of interest. Using the respective snapping points, the computer graphics processing application can perform the snapping operation to couple the moving object with the static object such that the moving object and the static object touch each other without overlapping.

The following non-limiting example is provided to introduce certain embodiments. In this example, a computer graphics processing application provides a graphical interface to display graphical objects including a moving object and a static object. As used herein, the term “graphical object” refers to electronic data that visually depicts content items via the graphical interface. Examples of a graphical object can include electronic graphical content (e.g., a line segment or shape) generated or modified with drawing tools, an electronic version of a photograph, etc.

The graphical objects can be part of an input design received by the computer graphics processing application. The computer graphics processing application can apply adjustments to the input design to generate an output design. In some scenarios, the computer graphics processing application can receive user input that can indicate a translation of the moving object from an original location in the graphical interface to a destination location in the graphical interface. For example, a user may provide the user input via a mouse, touchscreen, or other suitable input device by selecting and dragging the moving object from the original location to the destination location.

After receiving the user input indicating the translation of the moving object, the computer graphics processing application may generate an impact contour for the moving object that can translate with the moving object from the original location to the destination location in the graphical interface. The impact contour of the moving object can be offset by a predefined distance from a boundary (e.g., a perimeter, an outline, a contour, etc.) of the moving object. The boundary of the moving object can be referred to as a translated boundary. In some cases, the impact contour can differ from a bounding box of the moving object in that the impact contour mirrors contours of the moving object.

Based on a proximity of the moving object and the static object, the computer graphics processing application can determine whether to perform the snapping operation. For example, the computer graphics processing application can determine whether the impact contour of the moving object at the destination location intersects a static boundary of the static object. In some cases, the computer graphics processing application can apply a detection process to determine whether the impact contour intersects the static boundary. For instance, the computer graphics processing application can employ a broadphase detection technique to determine overlaps between the impact contour and the static object based on respective bounding boxes of Bezier curves forming the impact contour and the static object. After detecting at least one overlap between the respective bounding boxes of the Bezier curves using the broadphase detection technique, the computer graphics processing application can employ a narrowphase detection technique. In particular, the computer graphics processing application can use narrowphase detection to detect an intersection between the impact contour and the static boundary of the static object. The computer graphics processing application can employ the narrowphase detection by applying a subdivision algorithm to evaluate individual segments of the impact contour and the static boundary to identify overlapping segments or non-overlapping segments.

Based on whether the impact contour intersects the static boundary of the static object, the computer graphics processing application can determine whether to proceed with initiating the snapping operation. For instance, if the computer graphics processing application is unable to detect at least one intersection between the impact contour and the static object, the computer graphics processing application can adjust the position of the moving object without performing the snapping operation. Accordingly, the computer graphics processing application can generate the output design by moving the moving object from the original location to the destination location without snapping the moving object to the static object. Additionally, in some scenarios, a distance between the impact contour of the moving object and the static boundary of the static object may exceed a predefined tolerance associated with the snapping operation. As a result, the computer graphics processing application may avoid initiating the snapping operation when adjusting the position of the moving object to the destination location. For instance, the distance between the impact contour and the static boundary may exceed the predefined tolerance if the moving object is dragged past the static object to reach the destination location. Instead of executing the snapping operation, the computer graphics processing application can translate the moving object to the destination location such that the moving object remains uncoupled with the static object.

If the computer graphics processing application proceeds with the snapping operation, the computer graphics processing application can determine a pair of snapping points associated with the moving object and the static object to perform the snapping operation. For example, based on intersections of the impact contour and the static object, the computer graphics processing application can determine a respective region of interest of the moving object and the static object. Once the computer graphics processing application determines the respective regions of interest, the computer graphics processing application can apply a similarity search with respect to surface tangents of each region of interest. Using the similarity search, the computer graphics processing application can evaluate the surface tangents to determine a respective snapping point on the translated boundary of the moving object and the static boundary of the static object. The computer graphics processing application then can adjust the position of the moving object by a connection distance corresponding to a Euclidean distance between the respective snapping points of the moving object and the static object.

As described herein, certain embodiments provide improvements in image processing by facilitating object snapping based on contours of the moving object involved in the snapping operation. The snapping process utilizes the impact contour of the moving object that matches the contours of the moving object to determine the snapping points to perform the snapping operation. The contour-based snapping of the graphical objects thus improves the visual quality of the output design by accounting for the contours of the moving object during the snapping process. Thus, by using the impact contour to facilitate the snapping process, the computer graphics processing application can prevent gaps or overlap between the moving object and the static object.

### Example Operating Environment for Contour-Based Snapping of Graphical Objects

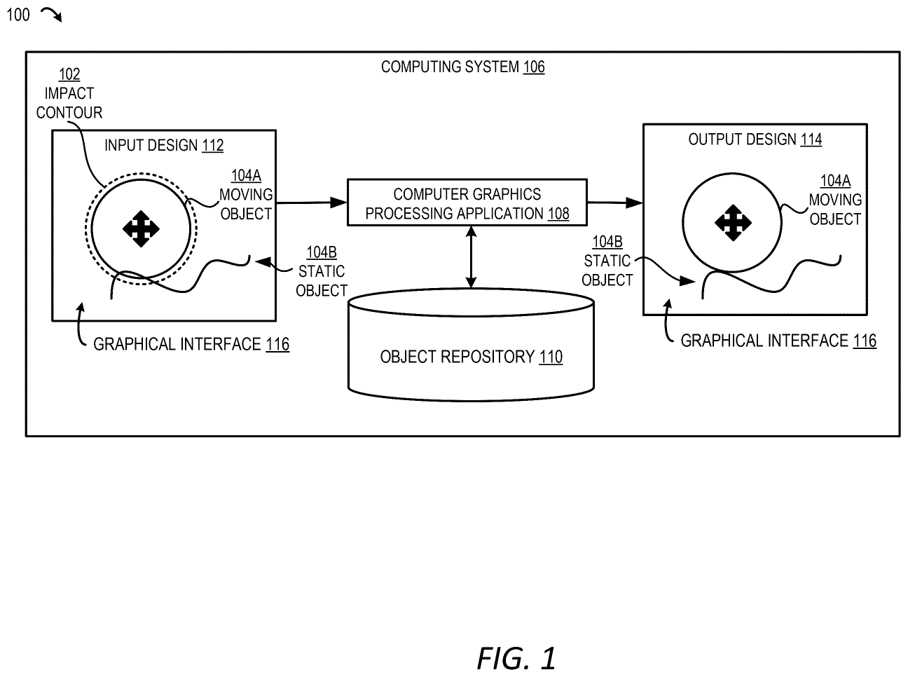

Referring now to the drawings, FIG. 1 depicts an example of a computing environment 100 for using an impact contour 102 of a moving object 104A to snap the moving object 104A with a static object 104B. Snapping the moving object 104A with the static object 104B can involve adjusting a position of the moving object 104A such that the moving object 104A is contiguous to the static object 104B without overlapping with the static object 104B. The computing environment 100 includes a computing system 106, which can include a single processing device or multiple processing devices that execute a computer graphics processing application 108 to perform snapping operations.

The computing environment 100 further includes an object repository 110 for maintaining graphical objects displayed by the computer graphics processing application 108. In particular, the object repository 110 can maintain definitions of the graphical objects (e.g., the moving object 104A and the static object 104B) that are accessible by the computer graphics processing application 108. For example, the object repository 110 can include a database, tables of a database, text files, or other suitable storage objects. The definitions of the graphical objects can describe or indicate a size, shape, or position of a corresponding graphical object. For instance, each graphical object can be represented in the object repository 110 as a respective definition in the form of a data structure of the object repository 110. In one example, if a graphical object is a polyhedron, such as a rectangle, then the graphical object can be stored as ordered sets of vertices such that each set of vertices defines a face of the polyhedron.

Additionally, the definitions of the graphical objects can correspond to path segments that can define boundaries of the graphical objects. For example, the graphical objects may be generated using multiple straight or curved path segments. In some cases, the path segments may form a closed path, resulting in a two-dimensional shape (e.g., a circle, a rectangle, a polygon, etc.) as the graphical object. For instance, multiple curved path segments coupled together as a continuous curve can form a perimeter of a circle. In other cases, the path segments can form an open path with distinct endpoints, such as a line segment. In some examples, the path segments can correspond to individual Bezier curves such that the boundaries of the graphical objects can be represented by combinations of linked Bezier curves.

The computer graphics processing application 108 can receive an input design 112 that contains the moving object 104A and the static object 104B. As one example, the computer graphics processing application 108 may receive the input design 112 as a file or a container including data associated the objects 104A-B. The data provided as part of the input design 112 can include respective shape data associated with each individual object and its corresponding properties (e.g., height, width, angle, color, position, etc.). The computer graphics processing application 108 can display contents of the input design 112, such as the objects 104A-B, as part of a graphical interface 116 that a user can interact with to implement modifications to the input design 112. In some cases, the computer graphics processing application 108 additionally can receive an indication of movement corresponding to the moving object 104A as part of the user interacting with the graphical interface 116. For instance, the moving object 104A may be translated toward the static object 104B from an original position to a destination location of the graphical interface 116 based on user input received by the computing system 106, such as via an input device. In some examples, the computer graphics processing application 108 may receive the input design 112 from another software module within or outside the computer graphics processing application 108.

The user may provide the indication of movement associated with the moving object 104A by selecting and dragging the moving object 104A to the destination location to initiate a drag event. While the drag event is ongoing (e.g., before the user releases the moving object 104A), the computer graphics processing application 108 can store the path segments of the moving object 104A to update from the original position to the destination position. The destination position can correspond to a reference position associated with a pointer or other suitable indicator of the input device used by the user to initiate the movement of the moving object 104A. For example, if the user uses a mouse as the input device to select and drag the moving object 104A, the computer graphics processing application 108 can use a pointer position updated in the drag event as the reference position. Accordingly, the computer graphics processing application can transform the path segments of the moving object 104A from the original position of the moving object 104A to the pointer position as the destination position.

Once the path segments of the moving object 104A are transformed to the updated position, the computer graphics processing application 108 can generate the impact contour 102 of the moving object 104A. Generating the impact contour 102 can involve inflating a boundary of the moving object 104A by an offset radius. The boundary of the moving object 104A can be referred to as a translated boundary or as a first boundary. In some cases, the offset radius can be a predefined distance that can be customizable by the user. The impact contour 102 can enable the computer graphics processing application 108 to detect intersection points between the moving object 104A and the static object 104B while the objects 104A-B are within a predefined distance apart. When the moving object 104A is translated due to the user input, geometry of the moving object 104A can remain unaffected throughout the drag event. By leveraging this geometry invariance, the impact contour 102 can be created when the drag event is initiated. When the moving object 104A is translated, the impact contour 102 can be translated along with the moving object 104A.

Based on the impact contour 102, the computer graphics processing application 108 can apply intersection detection techniques to determine whether the impact contour 102 intersects the static object 104B. If the impact contour 102 does not intersect the static object 104B, the computer graphics processing application 108 can avoid performing a snapping operation. Although one static object is depicted in the input design 112 of FIG. 1, it will be appreciated that more than one static object may be present in the graphical interface 116. In some cases, if multiple static objects are present in the graphical interface 116, the computer graphics processing application 108 can use the impact contour 102 to narrow down a list of target objects to evaluate with respect to performing the snapping operation. In particular, if a subset of the static objects does not intersect the impact contour 102, the computer graphics processing application 108 can remove the subset of the static objects from the list of target objects. After identifying the static object 104B that intersects the impact contour 102 of the moving object 104A, the computer graphics processing application 108 can proceed with initiating the snapping operation to adjust the moving object 104A to contact the static object 104B.

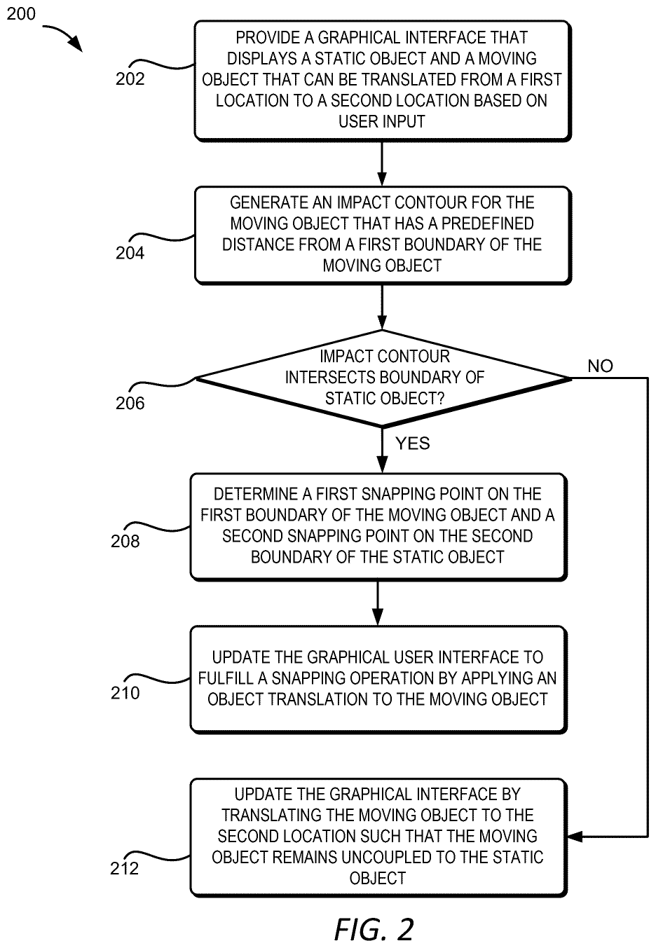

To snap the moving object 104A with the static object 104B, the computer graphics processing application 108 can determine an individual snapping point on a respective boundary of the moving object 104A and the static object 104B. In other words, the computer graphics processing application 108 can generate a pair of snapping points with a first snapping point on the boundary of the moving object 104A and a second snapping point on the boundary of the static object 104B. The first snapping point and the second snapping point are referred to herein as a subject snapping point and a target snapping point, respectively. Based on the pair of snapping points, the computer graphics processing application 108 can update the graphical interface 116 of the computing system 106 to move the moving object 104A such that the moving object 104A is contiguous to the static object 104B. For instance, the computer graphics processing application 108 can update a position of the moving object 104A with respect to the static object 104B such that the individual snapping points of the pair of snapping points touch each other. Additional details regarding snapping graphical objects by identifying the snapping points on object contours of the moving object 104A and the static object 104B are described herein with respect to FIGS. 2-9.

FIG. 2 depicts an example of a process 200 for using an impact contour 102 of a moving object 104A to snap the moving object 104A with a static object 104B, according to certain embodiments of the present disclosure. A computing device (e.g., the computing system 106) may implement operations depicted in FIG. 2 by executing suitable program code (e.g., the computer graphics processing application 108). For illustrative purposes, the process 200 is described with reference to certain examples depicted in the figures. Other implementations, however, are possible.

At block 202, the process 200 involves providing a graphical interface 116 that displays graphical objects (e.g., a moving object 104A and a static object 104B). The computer graphics processing application 108 can generate the graphical interface 116 that includes the objects 104A-B based on an input design 112 that provides data indicating properties (e.g., size, shape, color, position, etc.) of the objects 104A-B. The moving object 104A can be translated (e.g., moved or dragged) in the graphical interface 116 from an original location indicated in the input design 112 to a destination location based on user input. For instance, the computer graphics processing application 108 can present the graphical interface 116 including the moving object 104A and the static object 104B to a user. The computer graphics processing application 108 then can receive the user input provided by the user to initiate a dragging operation by selecting and moving the moving object 104A to the destination location. In some examples, the original location of the moving object 104A can be referred to as a starting position of the moving object 104A. If the user provides the user input via an input/output (I/O) device, such as a mouse, the graphical interface can include a pointer corresponding to the I/O device that can indicate a reference position with respect to the dragging operation initiated by the user.

At block 204, the process 200 involves generating an impact contour 102 for the moving object 104A. In some examples, the impact contour 102 can be generated based on Bezier curve parameters of the boundary of the moving object 104A. As described above with respect to FIG. 1, Bezier curves can form the boundary of the moving object 104A. Each Bezier curve can be a parametric curve that includes a respective set of control points to define a respective continuous curve as the Bezier curve. For example, a cubic Bezier curve may be defined by four control points. Based on each set of control points or other suitable parameters of the Bezier curves, the computer graphics processing application 108 can generate the impact contour 102 to match the contours of the boundary of the moving object 104A.

Additionally, the impact contour 102 can have a predefined distance from the boundary of the moving object 104A. Accordingly, the impact contour 102 can be differentiated from the boundary of the moving object 104A based on the predefined distance. In some cases, the impact contour 102 can be referred to as an offset curve. The impact contour 102 can be defined by a set of points that lie a perpendicular distance ρ from a particular curve of the moving object 104A in R². ρ can also be referred to as an offset radius. For instance, if a parametric equation of the particular curve is defined by Equation 1 below:

$$P ( t ) = ( x ( t ) , y ( t ) ) \qquad ( 1 )$$

then the impact contour with offset radius ρ can be defined by Equation 2 below:

$$Ω ( ρ , P ( t ) ) = P ( t ) + ρ \frac{( {y}^{′} ( t ) , - {x}^{′} ( t ) )}{\sqrt{( {x}^{′2} ( t ) + {y}^{′2} ( t ) )}} \qquad ( 2 )$$

As described further below with respect to block 206, the impact contour 102 can facilitate a direction invariant process for the computer graphics processing application 108 to detect if the snapping operation is feasible.

At block 206, the process 200 involves, based on detecting that the impact contour 102 of the moving object 104A intersects a boundary of the static object 104B, determining a pair of snapping points. The pair of snapping points can include a subject snapping point on the boundary of the moving object 104A and a target snapping point on the boundary of the static object 104B. A computing device can execute program code from the computer graphics processing application 108 to implement block 206. For example, the computer graphics processing application 108 can employ an intersection detection module to determine whether the impact contour 102 intersects the static boundary of the static object 104B.

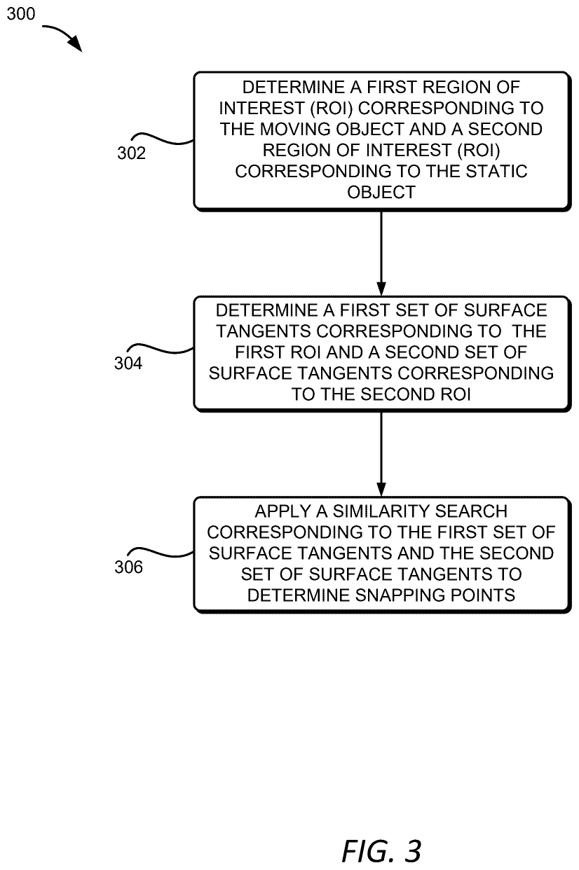

In some examples, the computer graphics processing application 108 can use intersection detection techniques to detect intersection points between the impact contour 102 and the boundary of the static object 104B. The intersection points can be referred to as collision points. In some cases, intersection detection can be referred to as collision detection. If the graphical interface includes more than one static object, applying the intersection detection technique(s) can narrow down the static object 104B as a target object to which the computer graphics processing application 108 can initiate the snapping operation for the moving object 104A. As one example, the computer graphics processing application 108 can remove certain static objects of the graphical interface from consideration based on whether the impact contour 102 overlaps with a respective bounding box of each static object in the graphical interface. The respective bounding box of each static object can correspond to an axis-aligned rectangular boundary around each static object that can define a location and a size of each static object. If the impact contour 102 does not overlap the bounding box of a particular static object, the computer graphics processing application 108 can remove the particular static object from a list of potential target objects. Based on the intersection points determined using the intersection detection technique(s), the computer graphics processing application 108 can determine the pair of snapping points. Additional details regarding determining the pair of snapping points are provided below with respect to FIG. 3.

At block 208, the process 200 involves updating the graphical interface 116 to execute a snapping operation by translating the moving object to the destination location where the subject snapping point and the target snapping point touch each other. Based on the pair of snapping points determined at block 206, the computer graphics processing application 108 can adjust the position of the moving object 104A by a connection distance between the subject snapping point and the target snapping point. Additionally, adjusting the position of the moving object 104A can involve moving the moving object 104A by the connection distance in alignment with a direction defined by the subject snapping point and the target snapping point.

FIG. 3 depicts an example of a process 300 for determining a respective snapping point for a moving object 104A and a static object 104B, according to certain embodiments of the present disclosure. The process 300 provides additional details associated with determining a pair of snapping points that is described above with respect to block 206 of the process 200. A computing device (e.g., the computing system 106) can implement operations depicted in FIG. 3 by executing suitable program code (e.g., the computer graphics processing application 108). For illustrative purposes, the process 300 is described with reference to certain examples depicted in the figures. Other implementations, however, are possible.

At block 302, the process 300 involves determining a first region of interest corresponding to the moving object 104A and a second region of interest corresponding to the static object 104B. The first region of interest and the second region of interest are referred to herein as a subject region of interest and a target region of interest, respectively. Using the impact contour 102, the computer graphics processing application 108 can perform an intersection detection process to determine whether the impact contour 102 intersects the boundary of the static object 104B. If the impact contour 102 overlaps the boundary of the static object 104B, the computer graphics processing application 108 can determine the intersection points based on the intersection detection process. The intersection points can define or be used to define the respective regions of interest of the moving object 104A and the static object 104B. In some scenarios, the impact contour 102 may not intersect the boundary of the static object 104B, resulting in the computer graphics processing application 108 translating the moving object 104A without performing the snapping operation.

In some examples, the computer graphics processing application 108 may perform the intersection detection in two phases: a broadphase detection and a narrowphase detection. The broadphase detection involves a lightweight technique to further reduce a search space with respect to the intersection detection at segment-level. In particular, the broadphase detection involves dividing the impact contour 102 into segments (e.g., Bezier curves) to perform a convex hull comparison with the boundary of the static object 104B. In some examples, the Bezier curves can be constructed from offset path segments. Each segment or Bezier curve of the impact contour 102 can include a respective bounding rectangle, similar to the bounding boxes of the static object described above. The computer graphics processing application 108 can implement the convex hull comparison by evaluating whether the respective bounding rectangles of the Bezier curves overlap the boundary of the static object 104B. In some cases, the boundary of the static object 104B can also be divided into individual segments, such as Bezier curves, when employing the broadphase detection.

Based on the broadphase detection, the computer graphics processing application 108 can identify overlapping segments or non-overlapping segments of the static object 104B and the impact contour 102. For example, if the bounding rectangles of a subset of the Bezier curves do not intersect the boundary of the static object 104B, the computer graphics processing application 108 can remove the subset of Bezier curves from further analysis. Consequently, applying the broadphase detection can result in a set of paired segments with each pair of segments including an individual segment from the impact contour 102 and the boundary of the static object 104B that overlap with each other.

Additionally, the computer graphics processing application 108 can apply the narrowphase detection to the remaining segments of the impact contour 102 after the broadphase detection. The narrowphase detection can involve applying a subdivision algorithm with respect to a cubic Bezier curve-curve intersection for every pair of Bezier curves remaining from the broadphase detection. In some cases, the narrowphase detection can be more costly in terms of computing resources. Accordingly, executing the narrowphase detection after the broadphase detection can conserve system resources of the computing system 106 with respect to detecting the intersection points of the impact contour 102 and the boundary of the static object 104B.

By employing the narrowphase detection, the computer graphics processing application 108 can obtain the intersection points shared by the impact contour 102 and the boundary of the static object 104B. As noted above, the intersection points can correspond to the respective regions of interest of the moving object 104A and the static object 104B. For example, the intersection points can indicate bounds (e.g., a starting point or an ending point) for the regions of interest on the moving object 104A and the static object 104B. In some scenarios, the narrowphase detection may output a set of Bezier curve parameters corresponding to the intersection points of the impact contour 102 and the static object 104B.

Due to the impact contour 102 matching the shape of the moving object 104A, the computer graphics processing application 108 can map the Bezier curve parameters to the translated boundary of the moving object 104A to determine the subject region of interest. As described above with respect to FIGS. 1-2, the impact contour 102 can be generated based on Bezier curves forming the boundary of the moving object 104A. Using the relationship between the respective Bezier curves of the moving object 104A and the impact contour 102, the computer graphics processing application 108 can map the Bezier curve parameters associated with the impact contour 102 to the boundary of the moving object 104A. As indicated below in Equation 3 and Equation 4 with P representing the moving object 104A and O representing the impact contour 102, the moving object 104A and the impact contour 102 can be related based on a parametric coordinate.

$$∀ p ∈ P : t = {P}^{- 1} ( p ) \qquad ( 3 )$$

$$∀ t ∈ [ 0 , 1 ] : {o}^{′} = O ( t ) \qquad ( 4 )$$

Accordingly, the computer graphics processing application 108 can use the Bezier curve parameters associated with the impact contour 102 to compute corresponding points on the moving object 104A. The corresponding points on the moving object 104A determined using the Bezier curve parameters can define the region of interest for the moving object 104A.

At block 304, the process 300 involves determining a first set of surface tangents corresponding to the subject region of interest and a second set of surface tangents corresponding to the target region of interest. The first set of surface tangents and the second set of surface tangents are referred to herein as subject surface tangents and target surface tangents, respectively. Each surface tangent of the subject surface tangents and the target surface tangents can touch the respective region of interest at a respective point, functioning as a straight-line approximation to the respective region of interest at each point. In some cases, the computer graphics processing application 108 can evaluate a set of points along the subject region of interest of the moving object 104A to determine the subject surface tangents. The computer graphics processing application 108 can similarly determine the target surface tangents for the target region of interest of the static object 104B. For example, the computer graphics processing application 108 can approximate a function to fit the target region of interest and calculate a derivative of the known function that can be used to determine a respective slope of each surface tangent that is part of the target surface tangents. In some cases, the computer graphics processing application 108 may determine subject surface normals for the subject region of interest and target surface normals for the target region of interest. Each surface normal can be perpendicular to the respective region of interest at a respective point on the respective region of interest.

At block 306, the process 300 involves applying a similarity search corresponding to the subject surface tangents and the target surface tangents to determine the subject snapping point and the target snapping point. Applying the similarity search can involve determining an individual surface tangent from the subject surface tangents and the target surface tangents to form a pair of surface tangents that are most similar to each other. For instance, the computer graphics processing application 108 can compute a similarity metric for the pair of surface tangents by determining an absolute value of an inner product of the pair of surface tangents. Since an ideal value of 1 for the similarity metric may be infeasible, the computer graphics processing application 108 can compare the similarity metric to a predefined threshold to ensure that the pair of surface tangents has a high degree of similarity. In some cases, the similarity search can be defined by Equation 5 below:

$$0.95 \leq max \vert 〈 v , w 〉 \vert \leq 1 ∧ 〈 v , v 〉 = 1 ∧ 〈 w , w 〉 = 1 \qquad ( 5 )$$

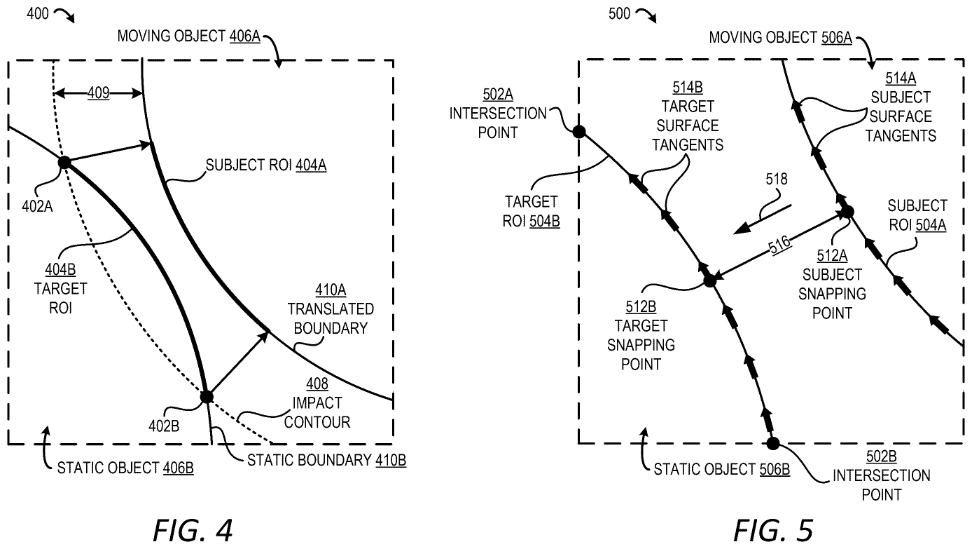

After determining the snapping points, the computer graphics processing application 108 can compute a connection distance between the snapping points. Based on whether the connection distance is within a predefined tolerance, the computer graphics processing application 108 can determine whether the snapping operation is feasible. The predefined tolerance can correspond to the predefined distance of the impact contour. In some examples, if the connection distance is within the predefined tolerance, the computer graphics processing application 108 can determine that the snapping operation is feasible and proceed with performing the snapping operation. In other examples, if the connection distance is outside of the predefined tolerance (e.g., exceeding the predefined tolerance), the computer graphics processing application 108 can update the position of the moving object 104A without performing the snapping operation. In other words, the computer graphics processing application 108 can translate the moving object 104A such that the moving object 104A passes through the static boundary of the static object 104B. Additional details regarding determining the regions of interest and applying the similarity search are described herein with respect to FIGS. 4-5.

In some cases, the computer graphics processing application 108 may determine the pair of snapping points based on a respective type of shape or geometry of the objects 104A-B. As one example, if the moving object 104A is a circle and the static object 104B is a straight line segment, the static object 104B may have one surface tangent. Accordingly, the computer graphics processing application 108 can select the closest tangent of the moving object 104A with respect to the surface tangent to the static object 104B to determine the subject snapping point on the moving object 104A. In this case, the closest tangent of the moving object 104A can be a surface tangent of the moving object 104A that is most similar to the surface tangent of the static object 104B. Additionally, based on a corresponding point of the closest tangent on the moving object 104A, the computer graphics processing application 108 can determine a surface normal perpendicular to the surface tangent of the moving object 104A at the corresponding point. The target snapping point of the static object 104B can correspond to a point of intersection determined by extending the surface normal to intersect the static object 104B.

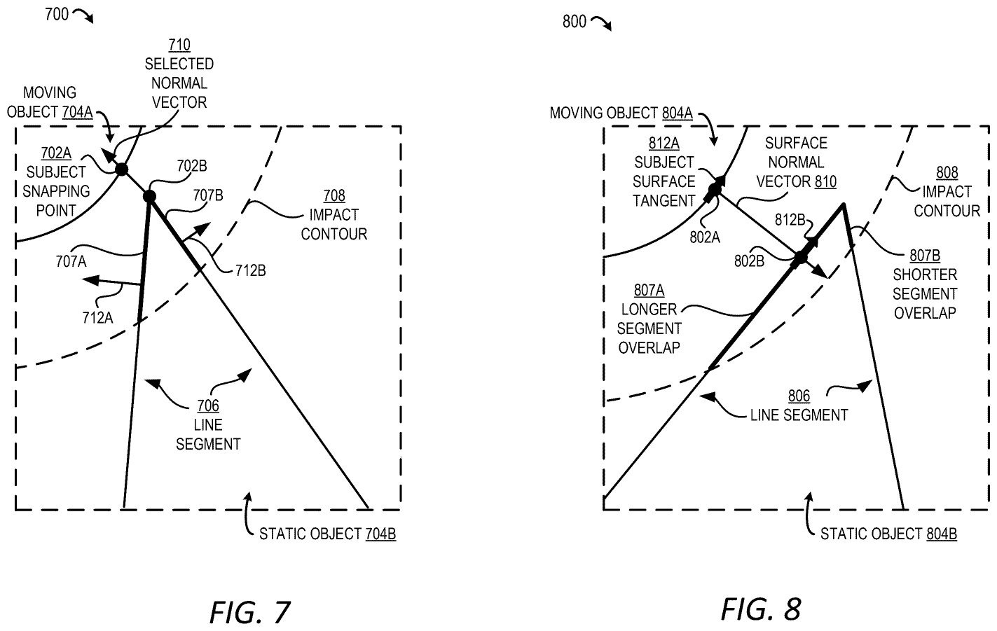

In some scenarios, the static object 104B may include a discontinuity, such as a vertex. For instance, two line segments of the static object 104B may meet at the same point to form a convex vertex having an internal angle less than π radians or 180°. In some cases, the vertex of the static object 104B can be referred to as a corner of the static object 104B. If the impact contour 102 of the moving object 104A overlaps the corner of the static object 104B, the computer graphics processing application 108 may be unable to compute a surface tangent corresponding to the corner of the static object 104B. For example, it may be mathematically infeasible to determine a tangent at a discontinuous point. Consequently, the computer graphics processing application 108 may employ alternative techniques to determine the pair of snapping points when at least one of the objects 104A-B includes a discontinuity. In some cases, the impact contour 102 may overlap at least a portion of both line segments that form the corner of the static object 104B. The computer graphics processing application 108 can determine the target snapping point of the static object 104B based on a respective amount of overlap for each line segment forming the corner. For example, if the respective amount of overlap for each line segment is similar (e.g., within a predefined range), the computer graphics processing application 108 may select the corner as the target snapping point of the static object 104B. As another example, if a line segment has a larger amount of overlap with the impact contour 102 than another line segment, the computer graphics processing application 108 can select a point on the line segment as the target snapping point of the static object 104B. Additional details regarding determining the target snapping point of the static object 104B with respect to a discontinuity are provided below with respect to FIGS. 7-8.

FIG. 4 depicts an example of a schematic 400 including a pair of intersection points 402A-B bounding a subject region of interest 404A for a moving object 406A and a target region of interest 404B for a static object 406B, according to certain embodiments of the present disclosure. The schematic 400 can provide a visualization of block 302 of the process 300 described above with respect to FIG. 3. In the example shown in FIG. 4, the pair of intersection points 402A-B correspond to two points at which an impact contour 408 of the moving object 406A intersects the static object 406B. The impact contour can be a predefined distance 409 apart from a translated boundary 410A of the moving object 406A. The computer graphics processing application 108 can apply intersection detection techniques, such as the techniques described above with respect to FIG. 3, to determine the intersection points 402A-B. Based on similarities of the contours of the moving object 406A and the impact contour 408, the computer graphics processing application 108 can map the pair of intersection points 402A-B back to the translated boundary 410A of the moving object 406A. In other words, the computer graphics processing application 108 can determine a respective point on the translated boundary 410A that corresponds to each intersection point of the pair of intersection points 402A-B. Accordingly, the computer graphics processing application 108 can determine the bounds of the subject region of interest 404A corresponding to the moving object 406A. The intersection points 402A-B on a static boundary 410B of the static object 406B can define the target region of interest 404B corresponding to the static object 406B. The regions of interest 404A-B can correspond to a respective search space within which the computer graphics processing application 108 can determine a pair of snapping points used to perform a snapping operation for the moving object 406A and the static object 406B.

After determining the regions of interest 404A-B, the computer graphics processing application 108 can evaluate points of the translated boundary 410A and the static boundary 410B within the regions of interest 404A-B to determine the snapping points. FIG. 5 depicts an example of a schematic 500 including a pair of snapping points 512A-B determined based on a similarity search of surface tangents 514, according to certain embodiments of the present disclosure. The schematic 500 can provide a visualization of block 304 of the process 300 described above with respect to FIG. 3. In the example shown in FIG. 5, the schematic 500 includes a respective set of surface tangents 514A-B corresponding to a translated boundary of a moving object 506A and a static boundary 410B of a static object 506B. For example, the computer graphics processing application 108 can sample individual points in the subject region of interest 504A to determine subject surface tangents 514A. Similarly, the computer graphics processing application 108 can sample individual points in the target region of interest 504B to determine target surface tangents 514B. As depicted in FIG. 5, the target region of interest 504B is bounded by intersection points 502A-B.

Once the computer graphics processing application 108 determines the surface tangents 514A-B, the computer graphics processing application 108 can employ a similarity search to compare the subject surface tangents 514A to the target surface tangents 514B. For example, the computer graphics processing application 108 may pair surface tangents from the subject surface tangents 514A with other surface tangents from the target surface tangents. The similarity search can output a respective similarity metric for each pair of surface tangents to indicate a corresponding degree of similarity between individual surface tangents of each pair of surface tangents. In some cases, the similarity metric can range from zero to one with one indicating the highest degree of similarity. Based on the similarity search, the computer graphics processing application 108 can determine a subject snapping point 512A within the subject region of interest 504A and a target snapping point 512B within the target region of interest 504B that are most similar to each other. In some scenarios, the computer graphics processing application 108 may determine the snapping points 512A-B based on a predefined threshold for the similarity metric that can indicate a minimum degree of similarity for the snapping points 512A-B.

After determining the snapping points 512A-B, the computer graphics processing application 108 can compute a connection distance 516 between the snapping points 512A-B by which to translate the moving object 506A to touch the static object 506B. The connection distance 516 can correspond to a linear (e.g., Euclidean) distance between the snapping points 512A-B. Referring to FIG. 4, the computer graphics processing application 108 can compare the connection distance 516 to a predefined distance 409 corresponding to an offset of the impact contour 408 with respect to the translated boundary 410A of the moving object 406A. If the connection distance 516 is less than the predefined distance 409, the computer graphics processing application 108 may proceed with performing the snapping operation. For example, based on an alignment defined by the snapping points 512A-B, the computer graphics processing application 108 can determine a direction 518 in which to translate the moving object 506A to perform a snapping operation. Accordingly, the computer graphics processing application 108 can adjust a position of the moving object 506A by the connection distance 516 in the direction 518 such that the subject snapping point 512A is contiguous to the target snapping point 512B.

In some examples, if the connection distance 516 is greater than the predefined distance 409, the computer graphics processing application 108 may translate the moving object 406A without executing the snapping operation. In other examples, the computer graphics processing application 108 can detach the moving object 406A from the static object 406B after performing the snapping operation if the connection distance 516 is greater than the predefined distance 409. For instance, after the computer graphics processing application 108 performs the snapping operation, the user may provide additional user input to translate the moving object 406A in the direction 518 such that the connection distance 516 between the objects 406A-B is greater than the predefined distance 409. Consequently, the computer graphics processing application 108 can decouple the objects 406A-B such that the moving object 406A is unaffected by any transformations applied to the static object 406B and vice versa.

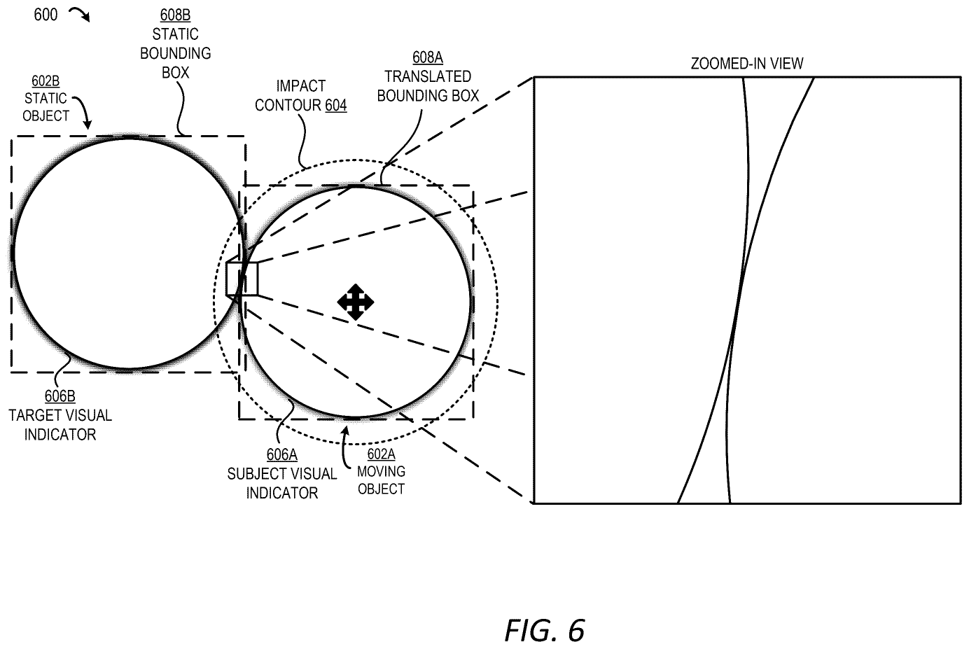

FIG. 6 depicts an example of an output design 600 including a moving object 602A snapped to a static object 602B by identifying collision points (e.g., snapping points) on object contours, according to certain embodiments of the present disclosure. The object contours can correspond to the boundaries of the objects 602A-B described above with respect to previous figures, such as FIGS. 4-5. Although FIGS. 4-6 depict a snapping operation involving two circles as the moving object 602A and the static object 602B, graphical objects with other suitable shapes or geometries can be snapped together using contour-based snapping.

The computer graphics processing application 108 can generate the output design 600 by performing a snapping operation to adjust a position of the moving object 602A by a connection distance determined using the impact contour 604 of the moving object 602A. As described above, by performing the snapping operation using the impact contour 604 of the moving object 602A, the computer graphics processing application 108 can translate the moving object 602A to touch the static object 602B without overlap. In the example of FIG. 6, the output design 600 includes a zoomed-in view of the connection between the moving object 602A and the static object 602B after the computer graphics processing application 108 has executed the snapping operation. Additionally, the objects 602A-B are highlighted using a respective visual indicator (e.g., a subject visual indicator 606A and a target visual indicator 606B) to indicate the execution of the snapping operation. In some scenarios, the visual indicators 606A-B can provide different colors or other suitable visual indications (e.g., patterns, opacity, line thickness, etc.) to accentuate and differentiate the moving object 602A and the static object 602B. The visual indicators 606A-B can provide visual feedback to a user initiating the snapping operation regarding which objects are involved in the snapping operation. The snapping operation can couple the objects 602A-B such that interacting with one object (e.g., the moving object 602A) of the objects 602A-B affects both objects 602A-B. For instance, after the snapping operation is performed, the objects 602A-B can be transformed (e.g., rotated, moved, dilated, etc.) as a single unit.

The output design additionally depicts a translated bounding box 608A corresponding to the moving object 602A that overlaps a static bounding box 608B corresponding to the static object 602B. The overlap between the bounding boxes 608A-B of the objects 602A-B that are snapped together illustrates deficiencies of performing a snapping operation using the bounding boxes 608A-B. Performing the snapping operation based on a respective bounding box (e.g., bounding boxes 608A-B) of the moving object 602A and the static object 602B can result in a suboptimal placement of the moving object 602A with respect to the static object 602B. For instance, snapping the moving object 602A to the static object 602B based on the bounding boxes 608A-B results in a gap between the objects 602A-B. In some scenarios, if at least one of the objects 602A-B is curved, the curvature can exacerbate an inaccuracy of the snapping operation performed based on the respective bounding boxes of the objects 602A-B. On the other hand, manually adjusting a position of the moving object 602A to mimic the snapping operation may similarly result in a suboptimal placement of the moving object 602A, such as resulting in an overlap between a respective boundary of the moving object 602A and the static object 602B.

FIGS. 7-8 illustrate examples of schematics including a snapping point of a static object including a discontinuous point overlapping an impact contour of a moving object. Although a single discontinuous point is shown in FIGS. 7-8, it will be appreciated that the static object may include more than one discontinuous point that can overlap the impact contour of the moving object. FIG. 7 depicts an example of a schematic 700 including a target snapping point 702B on a corner of a static object 704B, according to certain embodiments of the present disclosure. The static object 704B can include a pair of line segments 706 forming the corner and overlapping an impact contour 708 of a moving object 704A. Due to the corner of the static object 704B being a discontinuous point, the computer graphics processing application 108 may be unable to determine a surface tangent corresponding to the corner. Consequently, the computer graphics processing application 108 can compare a respective segment overlap (e.g., a longer segment overlap 707A and a shorter segment overlap 707B) of the line segments 706 with respect to the impact contour 708 to determine the target snapping point 702B. For example, as illustrated in the schematic 700, a difference in length of the segment overlap 707A-B is within a tolerable range such that the computer graphics processing application 108 can select the corner as the target snapping point 702B.

To determine a connection distance between the moving object 704A and the corner of the static object 704B, the computer graphics processing application 108 can determine a normal surface vector 710 to extend from the corner to intersect the moving object 704A. An intersection point of the normal surface vector 710 and the moving object 704A (e.g., a boundary of the moving object 704A) can function as a subject snapping point 702A. A linear distance between the snapping points 702A-B can correspond to the connection distance by which the computer graphics processing application 108 can translate the moving object 704A to perform a snapping operation. If the difference in length of the segment overlaps 707A-B is nonzero and within the tolerable range, the computer graphics processing application 108 can determine a weighted average of a respective amount of overlap for the segment overlaps 707A-B. Based on the weighted average, the computer graphics processing application 108 can select a normal surface vector 710 biased toward whichever segment overlap of the segment overlaps 707A-B is longer. For example, as illustrated in FIG. 7, the longer segment overlap 707A is slightly longer than the shorter segment overlap 707B. Accordingly, the selected normal surface vector 710 depicted in FIG. 7 is biased toward a longer normal surface vector 712A corresponding to the longer segment overlap 707A rather than toward a shorter normal surface vector 712B corresponding to the shorter segment overlap 707B.

FIG. 8 depicts a schematic 800 including two line segments 806 of a static object 804B forming a corner that overlaps an impact contour 808 of a moving object 804A. In contrast to the segment overlaps 807A-B of FIG. 7, the line segments 806 of FIG. 8 overlap with the impact contour 808 such that a longer segment overlap 807A has a significantly longer length than a shorter segment overlap 807B. In other words, a difference in length between the longer segment overlap 807A and the shorter segment overlap 807B can be higher than tolerable range described above with respect to FIG. 7. Based on the longer segment overlap 807A being significantly longer than the shorter segment overlap 807B, the computer graphics processing application 108 can determine that a target snapping point 802B is on the longer segment overlap 807A. For example, the computer graphics processing application 108 can follow a curve-line intersection logic path described above with respect to block 306 of FIG. 3 to determine a pair of snapping points 802A-B. In other words, the computer graphics processing application 108 can first determine a subject surface tangent 812A of the moving object 804A that is most similar to a target surface tangent 812B of the shorter segment overlap 807A. Based on the subject surface tangent 812A, the computer graphics processing application 108 can identify a subject snapping point 802A of the pair of snapping points 802A-B as a point on the boundary of the moving object 804A that corresponds to the subject surface tangent 812A. By extending a surface normal vector 810 corresponding to the subject surface tangent 812A to intersect the static object 804B, the computer graphics processing application 108 can determine a subject snapping point 802A of the pair of snapping points 802A-B.

### Computing System Example for Implementing Contour-Based Snapping of Graphical Objects

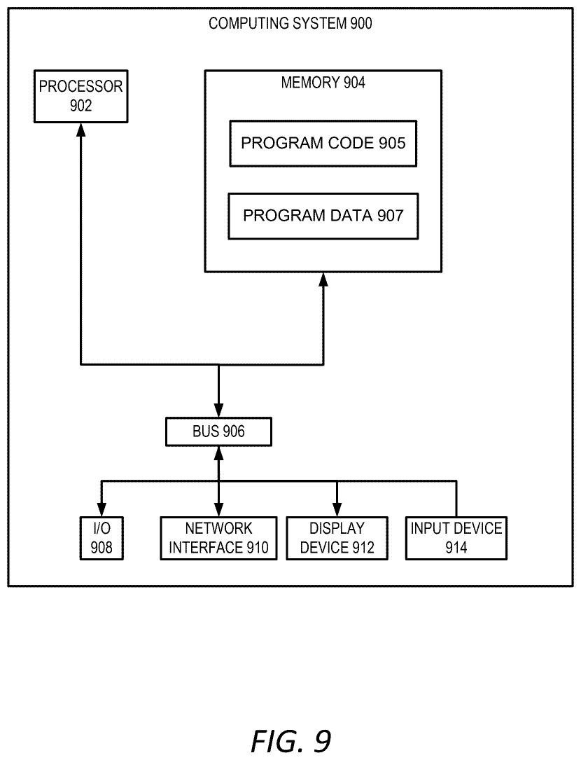

Any suitable computing system or group of computing systems can be used for performing the operations described herein. For example, FIG. 9 depicts an example of a computing system 900 that can implement the computing environment 100 of FIG. 1. In some embodiments, the computing system 900 includes a processing device 902 that executes the computer graphics processing application 108, a memory that stores various data computed or used by the computer graphics processing application 108, an input device 914 (e.g., a mouse, a stylus, a touchpad, a touchscreen, etc.), and a display device 912 that displays graphical content (e.g., a graphical interface, an output design, etc.) generated by the computer graphics processing application 108. For illustrative purposes, FIG. 9 depicts a single computing system on which the computer graphics processing application 108 is executed, and the display device 912 and input device 914 are present. But these applications, datasets, and devices can be stored or included across different computing systems having devices similar to the devices depicted in FIG. 9.

The depicted example of a computing system 900 includes a processing device 902 communicatively coupled to a memory device 904 (e.g., a single memory device or multiple memory devices). The processing device 902 executes computer-executable program code stored in a memory device 904, accesses information stored in the memory device 904, or both. Examples of the processing device 902 include a microprocessor, an application-specific integrated circuit (“ASIC”), a field-programmable gate array (“FPGA”), or any other suitable processing device. The processing device 902 can include any number of processing devices, including a single processing device.

The memory device 904 includes any suitable non-transitory computer-readable medium for storing program code 905, program data 907, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 900 may also include a number of external or internal devices, such as a display device 912, an input device 914, or other input or output devices. For example, the computing system 900 is shown with an input/output (“I/O”) interface 908. The I/O interface 908 can receive input from input devices or provide output to output devices. A bus 906 are also included in the computing system 900. The bus 906 communicatively couples components of the computing system 900.

The computing system 900 executes program code 905 that configures the processing device 902 to perform the operations described herein. The program code 905 includes, for example, the computer graphics processing application 108 or other suitable applications that perform operations described herein. The program code 905 may be resident in the memory device 904 or any suitable computer-readable medium and may be executed by the processing device 902 or any other suitable processor. In some embodiments, the computer graphics processing application 108 may include a single module or multiple modules to perform the snapping operation. For example, the computer graphics processing application 108 can include a module to detect intersections between objects and another module to determine snapping points based on the detected intersections. All modules in the computer graphics processing application 108 can be stored in the memory device 904. In additional or alternative embodiments, these modules from the computer graphics processing application 108 are stored in different memory devices of different computing systems.

In some embodiments, the computing system 900 also includes a network interface device 910. The network interface device 910 includes any device or group of devices suitable for establishing a wired or wireless data connection to a single data network or multiple data networks. Non-limiting examples of the network interface device 910 include an Ethernet network adapter, a modem, and/or the like. The computing system 900 can communicate with other computing devices (e.g., a computing device that receives inputs for computer graphics processing application 108 or displays outputs of the computer graphics processing application 108) via a data network using the network interface device 910.

The input device 914 can include any device or group of devices suitable for receiving visual, auditory, or other suitable input that controls or affects the operations of the processing device 902. Non-limiting examples of the input device 914 include a touchscreen, stylus, a mouse, a keyboard, a microphone, a separate mobile computing device, etc. The display device 912 can include any device or group of devices suitable for providing visual, auditory, or other suitable sensory output. Non-limiting examples of the display device 912 include a touchscreen, a monitor, a separate mobile computing device, etc.

Although FIG. 9 depicts the display device 912 and the input device 914 as being local to the computing device that executes the computer graphics processing application 108, other implementations are possible. For instance, in some embodiments, the display device 912, the input device 914, or a combination thereof can include a remote client-computing device that communicates with the computing system 900 via the network interface device 910 using the data networks.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A computer-implemented method in which one or more computing systems perform operations comprising:
providing a graphical interface that displays a plurality of graphical objects including a moving object and a static object, wherein the moving object is translatable in the graphical interface from a first location to a second location based on user input;
generating an impact contour for the moving object, the impact contour having a predefined distance from a first boundary of the moving object and configured to translate with the moving object as the moving object is translated from the first location to the second location;
based on detecting that the impact contour of the moving object intersects a second boundary of the static object, determining a first snapping point on the first boundary of the moving object and a second snapping point on the second boundary of the static object; and
updating the graphical interface to execute a snapping operation by translating the moving object to the second location where the first snapping point and the second snapping point touch each other.

2. The computer-implemented method of claim 1, wherein the first boundary of the moving object is defined based on a first set of curves, and wherein the impact contour is generated by projecting the first set of curves by a predefined offset to generate a second set of curves defining the impact contour.

3. The computer-implemented method of claim 1, wherein detecting that the impact contour of the moving object intersects the second boundary of the static object comprises:
identifying one or more overlapping segments of the static object and the impact contour of the moving object by comparing one or more Bezier curves used to form the second boundary of the static object and the impact contour; and
determining at least one intersection point of the static object and the impact contour by applying a subdivision algorithm to the one or more overlapping segments, wherein the subdivision algorithm is configured to determine one or more Bezier curve parameters corresponding to the at least one intersection point.

4. The computer-implemented method of claim 1, wherein determining the first snapping point of the moving object and the second snapping point of the static object comprises:
determining a first region of interest corresponding to the moving object and a second region of interest corresponding to the static object, wherein the respective regions of interest are defined based on at least one intersection point of the static object and the impact contour;
determining a first set of surface tangents corresponding to a first plurality of points forming the first region of interest and a second set of surface tangents corresponding to a second plurality of points forming the second region of interest; and
applying a similarity search corresponding to the first set of surface tangents and the second set of surface tangents to determine the first snapping point and the second snapping point, wherein a similarity metric between a first surface tangent corresponding to the first snapping point and a second surface tangent corresponding to the second snapping point is above a predefined threshold.

5. The computer-implemented method of claim 4, wherein determining the first region of interest of the moving object comprises mapping one or more Bezier curve parameters of the at least one intersection point on the impact contour of the moving object to the first boundary of the moving object.

6. The computer-implemented method of claim 4, wherein determining the first snapping point of the moving object and the second snapping point of the static object further comprises:
determining that the second region of interest includes a vertex formed by a first line segment and a second line segment;
determining that a first segment overlap for the first line segment is greater than a second segment overlap for the second line segment, wherein the first segment overlap and the second segment overlap are defined with respect to the impact contour overlapping with the first line segment and the second line segment, respectively; and
applying the similarity search to the first region of interest and the first line segment of the second region of interest to determine the first snapping point and the second snapping point.

7. The computer-implemented method of claim 1, wherein translating the moving object to the second location comprises:
determining a connection distance based on the first snapping point and the second snapping point, wherein the connection distance corresponds to a linear distance between the first snapping point and the second snapping point; and
translating the moving object by the connection distance in alignment with a direction defined by the first snapping point and the second snapping point.

8. The computer-implemented method of claim 1, wherein updating the graphical interface further comprises:
determining that a connection distance between the first boundary of the moving object and the second boundary of the static object is outside of a predefined tolerance associated with the connection distance; and
based on the connection distance being outside of the predefined tolerance, updating the graphical interface by translating the moving object from the first location to the second location such that the moving object remains uncoupled to the static object.

9. The computer-implemented method of claim 1, wherein updating the graphical interface further comprises generating a visual indicator associated with the second boundary of the static object and the first boundary of the moving object to indicate execution of the snapping operation.

10. A system comprising:
a processing device; and
a non-transitory computer-readable medium communicatively coupled to the processing device, wherein the processing device is configured to execute program code stored in the non-transitory computer-readable medium and thereby perform operations comprising:
providing a graphical interface that displays a plurality of graphical objects including a moving object and a static object, wherein the moving object is translatable in the graphical interface from a first location to a second location based on user input;
generating an impact contour for the moving object, the impact contour having a predefined distance from a first boundary of the moving object and configured to translate with the moving object as the moving object is translated from the first location to the second location;
based on detecting that the impact contour of the moving object intersects a second boundary of the static object, determining a first snapping point on the first boundary of the moving object and a second snapping point on the second boundary of the static object; and
updating the graphical interface to execute a snapping operation by translating the moving object to the second location where the first snapping point and the second snapping point touch each other.

11. The system of claim 10, wherein the first boundary of the moving object is defined based on a first set of curves, and wherein the impact contour is generated by projecting the first set of curves by a predefined offset to generate a second set of curves defining the impact contour.

12. The system of claim 10, wherein detecting that the impact contour of the moving object intersects the second boundary of the static object comprises:
identifying one or more overlapping segments of the static object and the impact contour of the moving object by comparing one or more Bezier curves used to form the second boundary of the static object and the impact contour; and
determining at least one intersection point of the static object and the impact contour by applying a subdivision algorithm to the one or more overlapping segments, wherein the subdivision algorithm is configured to determine one or more Bezier curve parameters corresponding to the at least one intersection point.

13. The system of claim 10, wherein determining the first snapping point of the moving object and the second snapping point of the static object comprises:
determining a first region of interest corresponding to the moving object and a second region of interest corresponding to the static object, wherein the respective regions of interest are defined based on at least one intersection point of the static object and the impact contour;
determining a first set of surface tangents corresponding to a first plurality of points forming the first region of interest and a second set of surface tangents corresponding to a second plurality of points forming the second region of interest; and
applying a similarity search corresponding to the first set of surface tangents and the second set of surface tangents to determine the first snapping point and the second snapping point, wherein a similarity metric between a first surface tangent corresponding to the first snapping point and a second surface tangent corresponding to the second snapping point is above a predefined threshold.

14. The system of claim 13, wherein determining the first region of interest of the moving object comprises mapping one or more Bezier curve parameters of the at least one intersection point on the impact contour of the moving object to the first boundary of the moving object.

15. The system of claim 13, wherein determining the first snapping point of the moving object and the second snapping point of the static object further comprises:
determining that the second region of interest includes a vertex formed by a first line segment and a second line segment;
determining that a first segment overlap for the first line segment is greater than a second segment overlap for the second line segment, wherein the first segment overlap and the second segment overlap are defined with respect to the impact contour overlapping with the first line segment and the second line segment, respectively; and
applying the similarity search to the first region of interest and the first line segment of the second region of interest to determine the first snapping point and the second snapping point.

16. The system of claim 10, wherein translating the moving object to the second location comprises:
determining a connection distance based on the first snapping point and the second snapping point, wherein the connection distance corresponds to a linear distance between the first snapping point and the second snapping point; and
translating the moving object by the connection distance in alignment with a direction defined by the first snapping point and the second snapping point.

17. The system of claim 10, wherein updating the graphical interface further comprises:
determining that a connection distance between the first boundary of the moving object and the second boundary of the static object is outside of a predefined tolerance associated with the connection distance; and
based on the connection distance being outside of the predefined tolerance, updating the graphical interface by translating the moving object from the first location to the second location such that the moving object remains uncoupled to the static object.

18. A non-transitory computer-readable medium having program code that is stored thereon, the program code executable by one or more processing devices for performing operations comprising:
providing a graphical interface that displays a plurality of graphical objects including a moving object and a static object, wherein the moving object is translatable in the graphical interface from a first location to a second location based on user input;
a step for generating an impact contour for the moving object, the impact contour having a predefined distance from a first boundary of the moving object and configured to translate with the moving object as the moving object is translated from the first location to the second location;
a step for detecting that the impact contour of the moving object intersects a second boundary of the static object;
a step for determining a first snapping point on the first boundary of the moving object and a second snapping point on the second boundary of the static object; and
updating the graphical interface to execute a snapping operation by translating the moving object to the second location where the first snapping point and the second snapping point touch each other.

19. The non-transitory computer-readable medium of claim 18, wherein the first boundary of the moving object is defined based on a first set of curves, and the impact contour is defined based on a second set of curves corresponding to the first set of curves.

20. The non-transitory computer-readable medium of claim 18, wherein updating the graphical interface further comprises:
determining that a connection distance between the first boundary of the moving object and the second boundary of the static object is outside of a predefined tolerance associated with the connection distance; and
based on the connection distance being outside of the predefined tolerance, updating the graphical interface by translating the moving object from the first location to the second location such that the moving object remains uncoupled to the static object.
